(19) United States
(12) Patent Application Publication
(10) Pub. No.: US 2020/0167401 A1
(43) Pub. Date: May 28, 2020

(54) PHOTO SHARING IN SOCIAL MEDIA NETWORKS

(71) Applicant: International Business Machines Corporation, Armonk, NY (US)

(72) Inventors: Tsai-Hsuan Hsieh, Taoyuan City (TW); Chiwen Chang, Taipei City (TW); Ci-Wei Lan, Keelung (TW); Kate Lin, Tainan City (TW); Peter Wu, New Taipei City (TW); Kuo-Liang Chou, Taipei (TW); I-Chien Lin, Taipei City (TW)

(21) Appl. No.: 16/200,811

(22) Filed: Nov. 27, 2018

(51) Int. Cl. G06F 16/9536; G06F 16/9535; G06F 16/2457; G06N 20/00

(52) U.S. Cl. CPC G06F 16/9536; G06N 20/00; G06F 16/24578; G06F 16/9535

(57) ABSTRACT

Determining a photo sharing suggestion regarding a photo to be shared by a user to a social media platform. The photo to be shared contains at least one other person than the user.

### BACKGROUND

The present invention relates to photo sharing, and more specifically to photo sharing in social media networks.

Within social networks, users share photos that can contain multiple people. However, not every one person present in the photo may welcome publishing such images to be shared online or within a social media network. People may not wish to have photos containing themselves shared by other users for numerous reasons, such as privacy concerns, personal preferences, and not being within a person's personal sharing tendency. Privacy concerns can include not wanting to be identified or tagged or have a photograph associated with their social identity on the social media network. Personal preferences can include not wanting pictures associated with certain locations. Personal sharing tendencies can include whether the person shares family photos, shares happy life events, shares only photos in specific locations, and shares photos taken in a certain way, etc. The user sharing the photo may be unaware of the sharing concerns of the people sharing their photo on a social media network.

### SUMMARY

According to one embodiment of the present invention, a method of determining a photo sharing suggestion to a user regarding a new photo containing at least one other person than the user to be shared by the user to a social media platform. The method comprising the steps of: a computer extracting raw metadata from the new photo; the computer retrieving primary information from the new photo; the computer determining secondary information from the new photo based on the primary information; the computer determining personalized and/or group preferences for sharing photos of at least the one other person in the new photo; the computer learning photo sharing behavior of at least the one other person in the new photo; and the computer providing a suggestion to the user for sharing the new photo to the social media platform.

According to another embodiment of the present invention, a computer program product for determining a photo sharing suggestion to a user regarding a new photo containing at least one other person than the user. The photo is to be shared by the user to a social media platform through a computer. The computer comprising at least one processor, one or more memories, one or more computer readable storage media, the computer program product comprising a computer readable storage medium having program instructions embodied therewith. The program instructions executable by the computer to perform a method comprising: extracting, by the computer, raw metadata from the new photo; retrieving, by the computer, primary information from the new photo; determining, by the computer, secondary information from the new photo based on the primary information; determining, by the computer, personalized and/or group preferences for sharing photos of at least the one other person in the new photo; learning, by the computer, photo sharing behavior of at least the one other person in the new photo; and providing, by the computer, a suggestion to the user for sharing the new photo to the social media platform.

According to another embodiment of the present invention, a computer system for determining a photo sharing suggestion to a user regarding a new photo containing at least one other person than the user. The photo is to be shared by the user to a social media platform through a computer system comprising a computer comprising at least one processor, one or more memories, one or more computer readable storage media having program instructions executable by the computer to perform the program instructions. The program instructions comprising: extracting, by the computer, raw metadata from the new photo; retrieving, by the computer, primary information from the new photo; determining, by the computer, secondary information from the new photo based on the primary information; determining, by the computer, personalized and/or group preferences for sharing photos of at least the one other person in the new photo; learning, by the computer, photo sharing behavior of at least the one other person in the new photo; and providing, by the computer, a suggestion to the user for sharing the new photo to the social media platform.

### BRIEF DESCRIPTION OF THE DRAWINGS

FIG. 1 depicts an exemplary diagram of a possible data processing environment in which illustrative embodiments may be implemented.

FIG. 2 illustrates internal and external components of a client computer and a server computer in which illustrative embodiments may be implemented.

FIG. 3 shows a flow diagram of a method of using advanced analytics to provide a photo sharing suggestion for a photo to be shared to a social media network containing at least one person who is not the user.

FIG. 4 shows a flow diagram of a method of learning photo sharing behavior of persons present within the photo to be shared to a social media network based on personalized preference matching and group tendency matching.

FIG. 5 shows a flow diagram of a method of determining representative feature selection for target tagged photos.

FIG. 6 shows a flow diagram of a method of learning photo sharing behavior of the user.

### DETAILED DESCRIPTION

It should be noted that throughout the description, the term “photo” refers to a digital photograph.

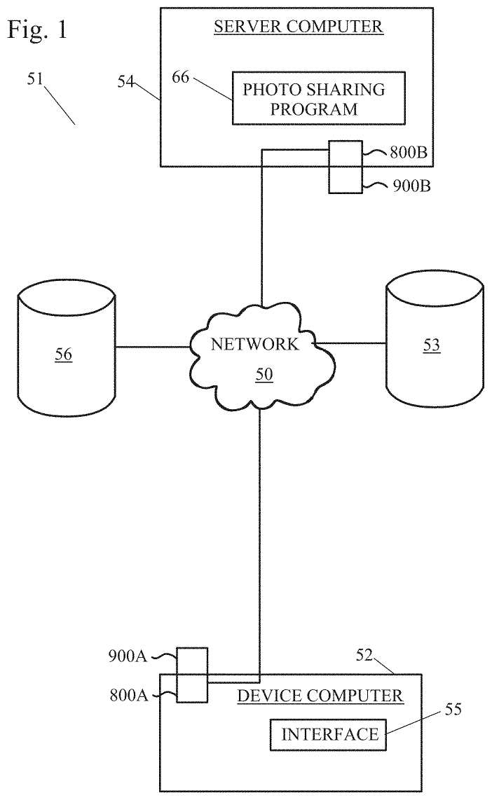

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a knowledge base repository 53, a contextual information model database 56 and a server computer 54 connect to network 50. In other exemplary embodiments, network data processing system 51 may include additional client or device computers, storage devices or repositories, server computers, and other devices not shown.

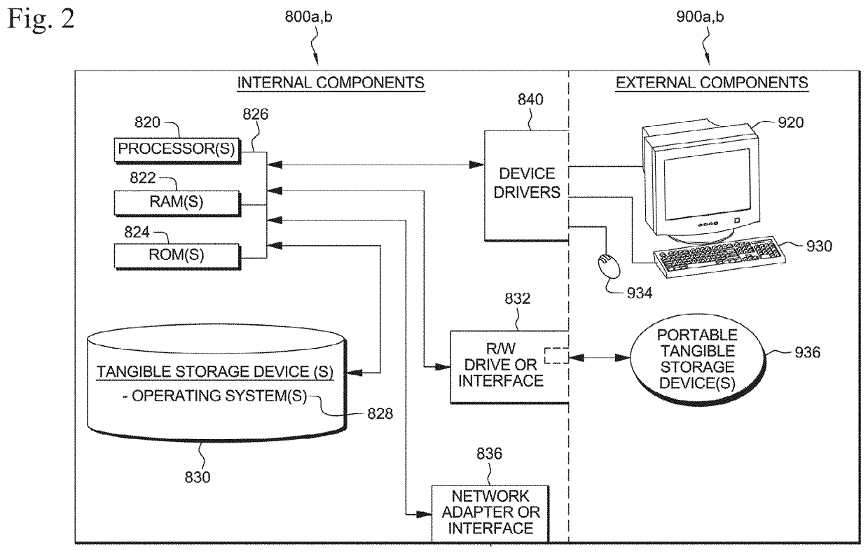

The device computer 52 may contain an interface 55, which may accept commands and data entry from a user. The commands may be regarding uploading and/or sharing photos of a plurality of persons to a social media network and providing a description and/or a tag associated with the photo(s). The interface can be, for example, a command line interface, a graphical user interface (GUI), a natural user interface (NUI) or a touch user interface (TUI). While not shown, the device computer 52 can additionally contain a repository with a plurality of photos. The device computer 52 may contain the photo sharing program 66. The device computer 52 includes a set of internal components 800a and a set of external components 900a, further illustrated in FIG. 2.

Server computer 54 includes a set of internal components 800b and a set of external components 900b illustrated in FIG. 2. In the depicted example, server computer 54 provides information, such as boot files, operating system images, and applications to the device computer 52. Server computer 54 can compute the information locally or extract the information from other computers on network 50. The server computer 54 preferably includes the photo sharing program 66. While not shown, it may be desirable to have the photo sharing program 66 be present on the device computer 52. In another embodiment, the photo sharing program 66 can be part of the social media network and embedded within the photo sharing process of the social media network. In an alternate embodiment, the photo sharing program 66 can be an application that is integrated with social media networks. For example, the user can send photos to the photo sharing program 66 and the photo sharing program 66 generates sharing recommendations such that the sharing of the photos on the social media network does not involve user involvement. In yet another embodiment, the photo sharing program 66 can search for photos uploaded based on user preferences.

Knowledge base database or repository 53 is connected to the network 50 and provides information to the photo sharing program 66 in regards to context information reasoning.

Contextual information model database 56 is connected to the network 50 and provides information to the photo sharing program 66 in regards to raw information retrieved regarding photo(s) to be shared on the social media network and to context information reasoning. The contextual information model 56 preferably includes user-defined context information.

Program code and programs such as photo sharing program 66 may be stored on at least one of one or more computer-readable tangible storage devices 830 shown in FIG. 2, on at least one of one or more portable computer-readable tangible storage devices 936 as shown in FIG. 2, or on repository 53, 56 connected to network 50, or may be downloaded to a device computer 52 or server computer 54, for use. For example, program code and programs such as photo sharing program 66 may be stored on at least one of one or more storage devices 830 on server computer 54 and downloaded to device computer 52 over network 50 for use. Alternatively, server computer 54 can be a web server, and the program code, and programs such as photo sharing program 66 may be stored on at least one of the one or more storage devices 830 on server computer 54 and accessed device computer 52. In other exemplary embodiments, the program code, and programs such as photo sharing program 66 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

FIG. 2 illustrates internal and external components of a device computer 52 and server computer 54 in which illustrative embodiments may be implemented. In FIG. 2, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and photo sharing program 66 are stored on one or more of the computer-readable tangible storage devices 830 for execution by one or more of the processors 820 via one or more of the RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Photo sharing program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Photo sharing program 66 can be downloaded to the device computer 52 and server computer 54 from an external computer via a network (for example, the Internet, a local area network or other, wide area network) and network adapter or interface 836. From the network adapter or interface 836, photo sharing program 66 is loaded into hard drive 830. Photo sharing program 66 can be downloaded to the server computer 54 from an external computer via a network (for example, the Internet, a local area network or other, wide area network) and network adapter or interface 836. From the network adapter or interface 836, photo sharing program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Photo sharing program 66 can be written in various programming languages including low-level, high-level, object-oriented or non object-oriented languages. Alternatively, the functions of a photo sharing program 66 can be implemented in whole or in part by computer circuits and other hardware (not shown).

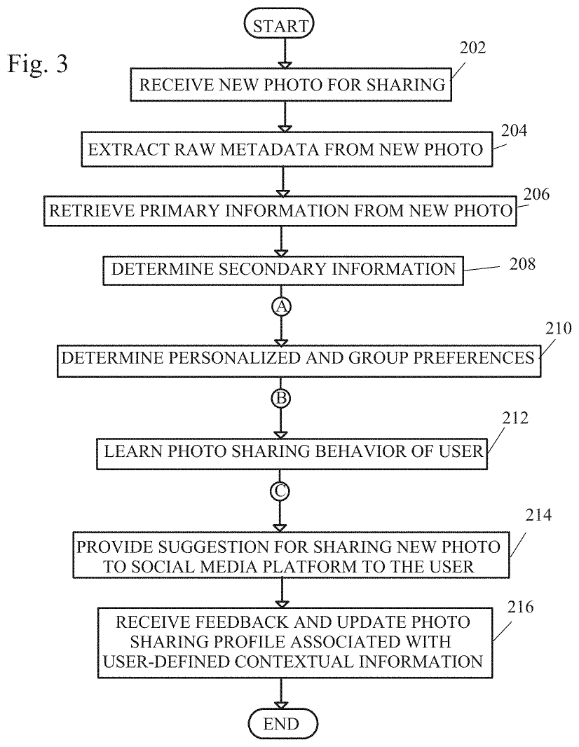

FIG. 3 shows a flow diagram of a method of using advanced analytics to provide a photo sharing suggestion for a photo to be shared to a social media network containing at least one person who is not the user.

In a first step, the photo sharing program 66 receives a new photo for potentially sharing through a social media network (step 202). The photo preferably contains at least one person other than the user who is sharing or uploading the new photo for potential sharing to a social media network. A photo can optionally include a tag provided by the user.

The photo sharing program 66 extracts raw metadata from the new photo (step 204). The raw metadata can include image resolution, date created, file name, etc. from the digital photo.

The photo sharing program 66 then retrieves primary information from the new photo based on user-defined contextual information and entity recognition training (step 206). Conventional image processing techniques of content based image retrieval uses pixel cluster indexing, histogram intersection, and discrete wavelet transform together to recognize entities within the new photo, such as who is in the photo and what is in the photo based on a user-defined contextual information model and an entity recognition training data set. The user defined contextual info model, in one embodiment, is a set of tuples {person, activity, time and date, place, etc.}. Conventional image process techniques are used to retrieve corresponding information. The training work will reply on the contextual info model to build learners.

Pixel cluster indexing is a determination of a certain range of pixel values. For example 100-255 either from gray level for monochromatic image or color image in red green blue (RGB) or hue saturation value (HSV) values, are selected and converted to an equivalent image of the original image i.e. in the equivalent image, the pixel value below 100 becomes 0 and all other pixels remain same position in the equivalent image as it is in the original image. Hence the equivalent image represents the original image. Query and the database images are converted to their equivalent images. The original image can be taken in smaller size either by cropping or nearest neighbor interpolation method for minimizing mathematical complexity. Then, the statistical parameters like standard deviation,\ and mean absolute deviation of the equivalent images are computed and are combined in normalized form. Thereafter, the combined values standard deviation and mean absolute deviation of the equivalent images derived from the query and database images respectively are compared by Euclidean distance method, and the nearest matching images to the query image are ranked accordingly.

Histogram intersection is computing a histogram of colors in a HSV model computed for the query as well as the database images respectively. The histograms of hue (H), saturation (S), value (V) are separately compared to the query and the database images. The minimum numbers of pixel values present in both the comparing histograms are taken for each position and are summed for the whole comparing image sizes. The total number of pixel values present is normalized and the best matching images for the query image are sorted out from a large image database of images associated with the user.

Discrete wavelet transform (DWT) uses a Daubechies filter. Since the approximation co-efficient matrix (CA2) up to two level decomposition of two-dimension (2-D) DWT consists of maximum information of the original image, these approximation co-efficient matrixes are taken for H,S,V values separately for both the query and the database images. Then statistical parameters like mean, standard deviation (std), and correlation co-efficient (corr) are calculated for H,S,V components of approximation co-efficient matrixes separately and these statistical parameters mean, std, corr are combined together in normalized form. The combined value of mean, std, corr in HSV components of the query and the database images are compared by Euclidean distance method and the best matching images are ranked accordingly.

The photo sharing program 66 determines secondary information through reasoning techniques and primary information (step 208). Secondary information is preferably semantic and is derived by reasoning techniques such as deductive reasoning.

To determine secondary information, the user-defined contextual information model selects reasoning logics, and in combination with primary information retrieved in step 206, uses rule matching to conclude secondary information. Rules which may be used are for example, the law of detachment and the law of syllogism. For the law of detachment, a single conditional statement is made and a hypothesis is stated. The conclusion is then deduced from the statement and the hypothesis. For the law of syllogism, two conditional statements are taken and a conclusion is formed by combining the hypothesis of one statement with the conclusion of another.

An example of a contextual information model may include {university classmates, eating, weekend, restaurant}, the reasoning techniques derive the secondary information of the photos with tags like “classmate gathering”, “university name”, “leisure event” etc.

The photo sharing program 66 then determines personalized and group preferences (step 210). The personalized and group preferences are preferably of the people present in the photo. The people present in the photo can be people other than the user which as initiating sharing of the photo and/or can include the user.

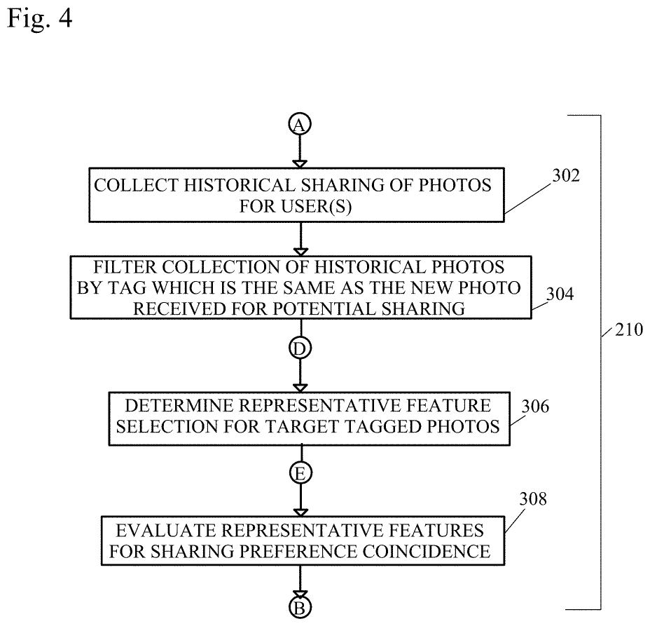

FIG. 4 shows the substeps of step 210 of determining personalized and group preferences. The method described below can be used to determine personalized preferences or group preferences. The method may be repeated to determine the other of personalized preferences or group preferences once a person or group preferences are determined.

In a first step historical sharing of photos for at least one of the people in the photo and the user is collected or retrieved (step 302). The collection of photos which have been historically shared by the group of people and/or an individual user are filtered by a tag which is the same as a tag of the new photo for potential sharing (step 304).

A representative feature selection from the historical collection of target tagged (same tag as tags of new photo) photos is determined (step 306).

The representative features of the historically shared photos with the same tag as the new photo to be potentially shared are evaluated for sharing preference coincidence with the features of the new photo (step 308) and the method returns to step 212 of FIG. 3.

The shared confidence evaluation approach by feature type can use cosine similarity for nominal features such that:

Confidence=cosine similarity

Similarity: if (Cosine Similarity)>0.5, then 1 else 0

For example,

TABLE 1

| | | Value in | | | |
|---|---|---|---|---|---|
| Feature | Feature | Historical | Value in | Simi- | Confi- |
| Name | Type | Photo | New Photo | larity | dence |
| Relationship | Nominal | Family = 3, | Friends | 0 | 0.41 |
| | | Friend = 2, | | | |
| | | Colleague = l | | | |
| Facial | Binary | Smile | Smile | 1 | 1 |
| Resolution | Nominal | 800 × 600 | 1024 × 768 | 1 | 0.75 |
| Add-on | Binary | No | Yes | 0 | 0.5 |
| Effects | | | | | |
| Over- | Binary | No | Yes | 0 | 0.5 |
| Exposure | | | | | |

TABLE 2
Rules for Binary Features

| Value in Historical | Value in New | | |
|---|---|---|---|
| Photo | Photo | Similarity | Confidence |
| True | True | 1 | 1 |
| False | False | 0 | 0 |
| True | False | 0 | 0.5 |
| False | True | 0 | 0.5 |

For the “relationship” feature,

Value in a historical photo based on Table 1: Family=3, Friend=2, Colleague=1

### Value in New Photo=1

$$Confidence = \frac{\sqrt{1}}{\sqrt{6} * \sqrt{1}} = 0.41$$

$$Similarity = 0 ( as confidence is less than 5 )$$

It should be noted that the confidence determination can be determined by the user.

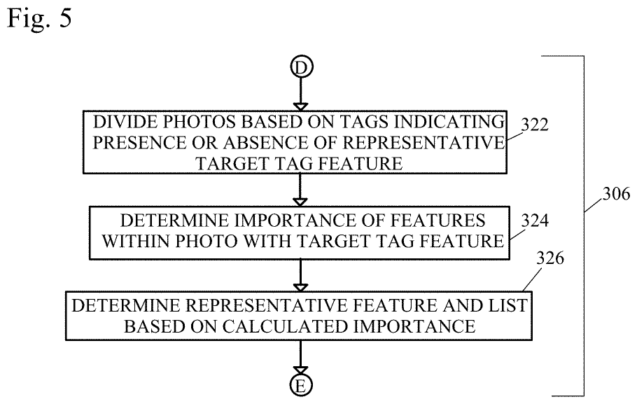

FIG. 5 shows the substeps of step 306 of determining a representative feature selection.

The personalized preference matching is based on representative feature selection. All of the historical photos of the at least one person in the photo and of the user which are recognized and which have been shared are retrieved (step 320). The personalized preference matching can include any recognized individuals in the photos.

The historical photos are divided into two groups to indicate the presence or absence of the representative target tag feature (step 322). For example, the historical photos with the tag and the associated features of those photos are set with a target of 1 and the historical photos without the tag and the associated features of those photos are set to 0.

The importance of all of the features within the photo with the target tag features is determined (step 324). For example, mining tools or software used for interactive, or batched, statistical analysis are used to determine the importance of features within the photos with the target tag set to 1.

At least one “representative” feature is then determined and the “representative” features are listed based on calculated importance (step 326) and the method returns to step 308 of FIG. 4.

For example, historically shared photos can have a tag of “#Birthday”. Features associated with photos with the tag “#Birthday” can be:

Feature 1: family
Feature 2: smile

### Feature 3: Pixel 800×600

Feature 4: no special effects
Feature 5: no backlighting.

The new photo to be potentially shared with a tag of “#Birthday” has the features of:

Feature 1: friends
Feature 2: smile

### Feature 3: Pixel 1024×768

Feature 4: special effects
Feature 5: backlighting.

The features are preferably ranked by importance. Therefore, in the new photo Feature 1 is the most important. The feature's importance is based on sharing history of recognized individual in the photo. For an individual, there are different calculated importance of features for a specific classification label. The calculated importance will alter along with the individual's new sharing.

Referring back to FIG. 3, the photo sharing program 66 learns photo sharing behavior of the user based on determined personalized and group preferences (step 212).

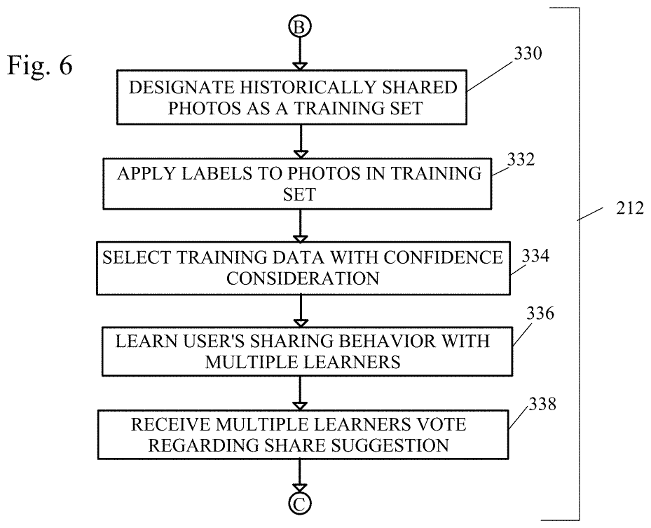

FIG. 6 shows a flow diagram of a method of step 212 of learning photo sharing behavior.

Photo sharing behavior learning uses confidence-based training selection. In a first step, historically shared photos are designated as a training set (step 330). The training set can be a portion of the at least one other person's or the user's historically shared photos or all of the at least one other persons' or user's historically shared photos.

Labels are applied to the photos in the training set (step 332). The historical photos are labeled “public” for publically shared photos and “non-public” for limited share photos.

Training data is then selected with a confidence consideration (step 334). The confidence consideration can be determined by feature level selection or record level selection. The features of the historical photos are stored in a database based on context retrieval, personalized preference matching and group tendency matching.

For each feature, reset value is ‘NULL’ if its confidence is lower than generated random number. If the majority of a record's feature confidence is greater than generated random number, the record is selected (without any change of feature value). Since training data confidence is not 100% for every training record, multiple sets of training data is selected for constructing multiple learners rather than constructing a single learner containing all training data.

For example, for features from context retrieval, features of personalized preference matching and features of tendency matching are used for confidence-based training (Table 3).

TABLE 3

| Feature | Value | Confidence |
|---|---|---|
| Feature Context Retrieval 1 | X | 1 |
| Feature Context Retrieval 2 | Y | 0.75 |
| Feature Context Retrieval n | . . . | . . . |

For features from personalized preference matching features of personalized preference matching and features of tendency matching are used for confidence-based training (Table 4).

TABLE 4

| Feature | Value | Confidence |
|---|---|---|
| Feature Personalized | 1 | 0.34 |
| Preference 1 | | |
| Feature Personalized | NULL | 0.95 |
| Preference 2 | | |
| Feature Personalized | . . . | . . . |
| Preference n | | |

For features from group tendency matching features of personalized preference matching and features of tendency matching are used for confidence-based training (Table 5).

TABLE 5

| Feature | Value | Confidence |
|---|---|---|
| Feature Group Tendency | NULL | 0.75 |
| Matching 1 | | |
| Feature Group Tendency | 1 | 0.69 |
| Matching 2 | | |
| Feature Group Tendency | . . . | . . . |
| Matching n | | |

Based on the confidence based training data of step 334, multiple learners can be constructed and behavior learned (step 336). Each learner can capture certain critical characteristics of sharing behavior. For example, one user can represent context, another learner personalized preference, and yet another learner group tendencies and so on.

For example, based on a tuple of {“context features”, “personalized preference”, “group tendency”}, and a given a historical record of {“business meeting” with confidence “0.8”, “colleagues” with confidence “0.7”, “people in photo tend to share” with confidence “0.72”}, learners can be built as follows. For each learner to be generated, first a random number between 0 and 1 is generated. For the sake of this example, assume that the number is 0.75. Next, feature confidences of each historical dataset are compared with the generated random number. The value is set as “NULL” if its confidence is less than the generated number. In this example, the given record (tuple) would be updated as {“business meeting”, “NULL”, “NULL”}. After the record value updates, these records are used to build a learner. This process would be repeated for each learner to be generated in this example.

Then, the multiple learners provide feedback regarding to share or not share the new photo and then the method returns to step 214 of FIG. 3. If more than half of the learners vote or provide ‘share’ feedback, then the suggestion is to share the new photo, otherwise the suggestion is not to share the photo.

Referring back to FIG. 3, the photo sharing program 66 provides a suggestion for sharing the new photo to the social media platform to the user (step 214).

Feedback is preferably received regarding the photo sharing suggestions and updates the photo sharing profile of the user within the user-defined contextual information model (step 216) and the method ends. It should be noted that if feedback is not received regarding the photo sharing suggestion after a set period of time, the method can end after step 214.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining a photo sharing suggestion to a user regarding a new photo containing at least one other person than the user, the photo to be shared by the user to a social media platform, the method comprising the steps of:
a computer extracting raw metadata from the new photo;
the computer retrieving primary information from the new photo;
the computer determining secondary information from the new photo based on the primary information;
the computer determining personalized and/or group preferences for sharing photos of at least the one other person in the new photo;
the computer learning photo sharing behavior of at least the one other person in the new photo; and
the computer providing a suggestion to the user for sharing the new photo to the social media platform.

2. The method of claim 1, further comprising the computer receiving feedback and the computer updating sharing preferences associated with at least the one other person.

3. The method of claim 1, wherein the step of the computer determining personalized and/or group preferences for sharing photos of the at least one other person in the new photo further comprises:
the computer retrieving historically shared photos from the at least one other person in the new photo and the user;
the computer filtering the historically shared photos by tags which are equivalent to tags associated with the new photo;
the computer determining representative features for historically shared photos with tags equivalent to tags associated with the new photo and the new photo; and
the computer evaluating the representative features for a coinciding sharing preference.

4. The method of claim 3, wherein the step of the computer determining representative features for historically shared photos with tags equivalent to tags associated with the new photo and the new photo further comprises:
the computer dividing the retrieved historically shared photos based on tags indicating a presence of a target tag feature;
the computer calculating an importance of all features within the retrieved historically shared photos based on the target tag feature;
the computer determining at least one representative feature(s) of the retrieved historically shared photos; and
the computer listing the features representing the retrieved historically shared photos based on the calculated importance.

5. The method of claim 1, wherein the step of the computer learning photo sharing behavior of at least the one other person in the new photo further comprises:
the computer designating a set of historically shared photos from the at least one other person in the new photo and the user as a training set;
the computer applying labels to photos within the training set;
the computer selecting training data with a confidence consideration;
the computer constructing multiple users to learn sharing behaviors representing at least context, personalized preference, and group tendencies; and
the computer receiving feedback from the multiple users to share or not share the new photo to the social media platform.

6. The method of claim 5, wherein the labels which are applied are public-representing photos which have been publically shared to the social media platform and nonpublic-representing photos which have not been publically shared to the social media platform.

7. The method of claim 5, wherein the confidence consideration is determined by feature level selection or record level section.

8. The method of claim 7, wherein for each feature, a value assigned to the feature is set to null if confidence in the feature is lower than a generated random number.

9. The method of claim 7, wherein in record level selection, records are selected when a majority of the records and associated feature confidence is greater than a generated random number.

10. The method of claim 1, wherein the primary information is based on content present within the photo and user-defined contextual data.

11. A computer program product for determining a photo sharing suggestion to a user regarding a new photo containing at least one other person than the user, the photo to be shared by the user to a social media platform through a computer, the computer comprising at least one processor, one or more memories, one or more computer readable storage media, the computer program product comprising a computer readable storage medium having program instructions embodied therewith, the program instructions executable by the computer to perform a method comprising:
extracting, by the computer, raw metadata from the new photo;
retrieving, by the computer, primary information from the new photo;
determining, by the computer, secondary information from the new photo based on the primary information;
determining, by the computer, personalized and/or group preferences for sharing photos of at least the one other person in the new photo;
learning, by the computer, photo sharing behavior of at least the one other person in the new photo; and
providing, by the computer, a suggestion to the user for sharing the new photo to the social media platform.

12. A computer system for determining a photo sharing suggestion to a user regarding a new photo containing at least one other person than the user, the photo to be shared by the user to a social media platform through a computer system comprising a computer comprising at least one processor, one or more memories, one or more computer readable storage media having program instructions executable by the computer to perform the program instructions comprising:
extracting, by the computer, raw metadata from the new photo;
retrieving, by the computer, primary information from the new photo;
determining, by the computer, secondary information from the new photo based on the primary information;
determining, by the computer, personalized and/or group preferences for sharing photos of at least the one other person in the new photo;
learning, by the computer, photo sharing behavior of at least the one other person in the new photo; and
providing, by the computer, a suggestion to the user for sharing the new photo to the social media platform.

13. The computer system of claim 12, further comprising receiving, by the computer, feedback and updating, by the computer, sharing preferences associated with at least the one other person.

14. The computer system of claim 12, wherein the program instructions of determining, by the computer, personalized and/or group preferences for sharing photos of the at least one other person in the new photo further comprises:
retrieving, by the computer, historically shared photos from the at least one other person in the new photo and the user;
filtering, by the computer, the historically shared photos by tags which are equivalent to tags associated with the new photo;
determining, by the computer, representative features for historically shared photos with tags equivalent to tags associated with the new photo and the new photo; and
evaluating, by the computer, the representative features for a coinciding sharing preference.

15. The computer system of claim 14, wherein the program instructions of determining, by the computer, representative features for historically shared photos with tags equivalent to tags associated with the new photo and the new photo further comprises:
dividing, by the computer, the retrieved historically shared photos based on tags indicating a presence of a target tag feature;
calculating, by the computer, an importance of all features within the retrieved historically shared photos based on the target tag feature;
determining, by the computer, at least one representative feature(s) of the retrieved historically shared photos; and
listing, by the computer, the features representing the retrieved historically shared photos based on the calculated importance.

16. The computer system of claim 12, wherein the program instructions of learning, by the computer, photo sharing behavior of at least the one other person in the new photo further comprises:
designating, by the computer, a set of historically shared photos from the at least one other person in the new photo and the user as a training set;
applying, by the computer, labels to photos within the training set;
selecting, by the computer, training data with a confidence consideration;
constructing, by the computer, multiple users to learn sharing behaviors representing at least context, personalized preference, and group tendencies; and
receiving, by the computer, feedback from the multiple users to share or not share the new photo to the social media platform.

17. The computer system of claim 16, wherein the labels which are applied are public-representing photos which have been publically shared to the social media platform and nonpublic-representing photos which have not been publically shared to the social media platform.

18. The computer system of claim 16, wherein the confidence consideration is determined by feature level selection or record level section.

19. The computer system of claim 18, wherein for each feature, a value assigned to the feature is set to null if confidence in the feature is lower than a generated random number.

20. The computer system of claim 18, wherein in record level selection, records are selected when a majority of the records and associated feature confidence is greater than a generated random number.
